(19) United States
(12) Patent Application Publication
(10) Pub. No.: US 2016/0203526 A1
(43) Pub. Date: Jul. 14, 2016

(54) SYSTEMS AND METHODS FOR MICRODONATIONS DERIVED FROM A CAPTURED RECEIPT IMAGE

(71) Applicants: Andra TOMSA, Bronx, NY (US); Rameet Singh CHAWLA, New York, NY (US)

(72) Inventors: Andra TOMSA, Bronx, NY (US); Rameet Singh CHAWLA, New York, NY (US)

(21) Appl. No.: 14/994,679

(22) Filed: Jan. 13, 2016

Related U.S. Application Data
(60) Provisional application No. 62/102,729, filed on Jan. 13, 2015.

(51) Int. Cl. G06Q 30/02; G06Q 20/10; G06Q 20/22

(52) U.S. Cl. CPC G06Q 30/0279; G06Q 20/29; G06Q 20/10

(57) ABSTRACT

A system and method for collecting microdonations of provided. Specifically, the system and its method of use provide a user with an easy way to scan and document the contents of a receipt, calculate the dollar amount necessary to bring the total to an integer amount, and facilitating the transfer of this dollar amount to at least one charity of a user's choice. In some instances, the system is also capable of generating these microdonations within a software application without the use of a paper receipt.

### CLAIM OF PRIORITY

This application claims priority to U.S. Provisional Patent Application No. 62/102,729, entitled “SYSTEMS AND METHODS FOR MICRODONATIONS DERIVED FROM A CAPTURED RECEIPT IMAGE,” filed on Jan. 13, 2015, the contents of which are hereby fully incorporated by reference.

### FIELD OF THE EMBODIMENTS

The present disclosure relates to micro-payment and donation systems and methods.

### BACKGROUND OF THE EMBODIMENTS

Despite all of mankind's advancements into various areas of science and technology, there still exist a number of serious problems in the world today. Often, when people think of famine, disease, and poverty, places outside of the United States are evoked. However, despite these common perceptions, there are many people in America today who are unable to afford basic meals. This phenomenon is known as the “meal gap.” That is, the lack of funds needed to give a community three square meals a day.

In New York City, for example, the meal gap is $58,000,000 or 235 million missing meals. There are many charitable organizations that attempt to cut the size of this gap, but when compared with all the other worthy charities out there, few are able to make any meaningful dent in the meal gap present in America. While there are these groups out there, they frequently employ antiquated fundraising techniques, which result in lackluster amounts of donations. With the rise of crowdfunding and microdonations, combined with the growing social consciousness of the American public, there exists a need for a system and method that utilize crowdfunding techniques, streamline the microdonation process, and help encourage others to give in a way that helps close this meal gap.

Examples of related art are described below:

United States Patent Publication No. 2012/0303516 discloses a virtual payment system and method for creating and processing donations and payments, specifically micro donation payments to a Merchant.

United States Patent Publication No. 2013/0253993 discloses a system and method by which micro-donations are received from users for various items of content, published by different content providers who provide incentives for increased participation.

United States Patent Publication No. 2013/0197992 teaches a method and system for generating real-time rewards, loyalty points, and advertising using a mobile application and quick response codes.

United States Patent Publication No. 2009/0182586 teaches computer program adapted to host; accrue; calculate; disburse and report monthly donations earned by a participating merchant, wherein the merchants receive a point-of-sale benefit related to the payment processing transactions in the form of a donation based upon transaction totals.

United States Patent Publication No. 2014/0129447 discloses a method of processing anonymous micro-transactions of any type, such as purchases, donations, subscriptions and rewards.

Lastly, United States Patent Publication No. 2013/0230246 teaches a receipt image processing service wherein a template is used to extract receipt data from the receipt image which is then provided to an expense report system.

None of the art described above addresses all of the issues that the present invention does. Generally, the present invention provides a system and method that allows a user to round up, to the nearest dollar amount, their check at a restaurant or other establishment, and subsequently donate that extra money directly to at least one charity of their choosing.

### SUMMARY OF THE EMBODIMENTS

The present invention provides for a method for collecting microdonations, comprising the steps of: providing an internet-enabled computing device comprising: a memory, for holding a set of computer-readable instructions, a processor, operatively connected to said memory, said processor configured to execute said set of computer-readable instructions, an image capture device in electronic communication with said processor; linking, a user financial account with a user account; calculating, by said processor, a monetary value for a transaction taken from a statement from said user financial account; calculating, by said processor, a monetary difference between the monetary value and the next largest whole dollar amount; sending, by said processor, the monetary difference to a designated financial account. In some embodiments, the designated financial account belongs to a charitable organization, and in others it belongs to an individual. Preferably, the monetary difference is less than $1.00. In alternative embodiments, the method of the present invention, further comprises the steps of: associating, by said processor, said monetary difference with a user account; adding, said monetary difference to a balance in said user account; determining, by said processor, a reward level to connect with said user account, wherein said determination is directly proportional to said balance. Preferably, the balance is reset on a preset interval.

Additionally, the method of the present invention may also comprise the steps of determining, by said processor, an impact level of said user account, wherein said impact level corresponds to said balance, and the number of monetary differences added to said balance over a predetermined amount of time and/or providing, a redemption mechanism to said user account, wherein said redemption mechanism allows a user account to be credited with at least one reward, wherein said at least one reward corresponds to said reward level.

The present invention also contemplates a system for collecting microdonations, comprising: a memory, for holding a set of computer-readable instructions, a processor, operatively connected to said memory, said processor configured to execute said set of computer-readable instructions, an image capture device operatively connected to said processor, wherein said processor is configured to perform the steps of: registering, by said processor, a user account associated with a user; linking, a user financial account with a user account; calculating, by said processor, a monetary value for a transaction taken from a statement from said user financial account; linking, a user financial account with a user account; calculating, by said processor, a monetary value for a transaction taken from a statement from said user financial account; calculating, by said processor, a monetary difference between the monetary value and the next largest whole dollar amount; sending, by said processor, the monetary difference to a designated financial account associating, by said processor, said monetary difference with a user account; adding, said monetary difference to a balance in said user account; determining, by said processor, a reward level to connect with said user account, wherein said determination is directly proportional to said balance; determining, by said processor, an impact level of said user account, wherein said impact level corresponds to said balance, and the number of monetary differences added to said balance over a predetermined amount of time; providing, a redemption mechanism to said user account, wherein said redemption mechanism allows a user account to be credited with at least one reward, wherein said at least one reward corresponds to said reward level.

It is an object of the invention to provide a system for collecting charitable donations from users.

It is an object of the invention to provide an easy way for users to donate to charity.

It is an object of the invention to provide a system capable of being implemented across a number of different platforms that is capable of collecting and accounting for a large number of charitable financial transactions.

### BRIEF DESCRIPTION OF THE DRAWINGS

FIG. 1 is a flow chart showing an embodiment of the method of the present invention.

### DESCRIPTION OF THE PREFERRED EMBODIMENTS

The preferred embodiments of the present invention will now be described with reference to the drawings. Identical elements in the various FIGURES are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

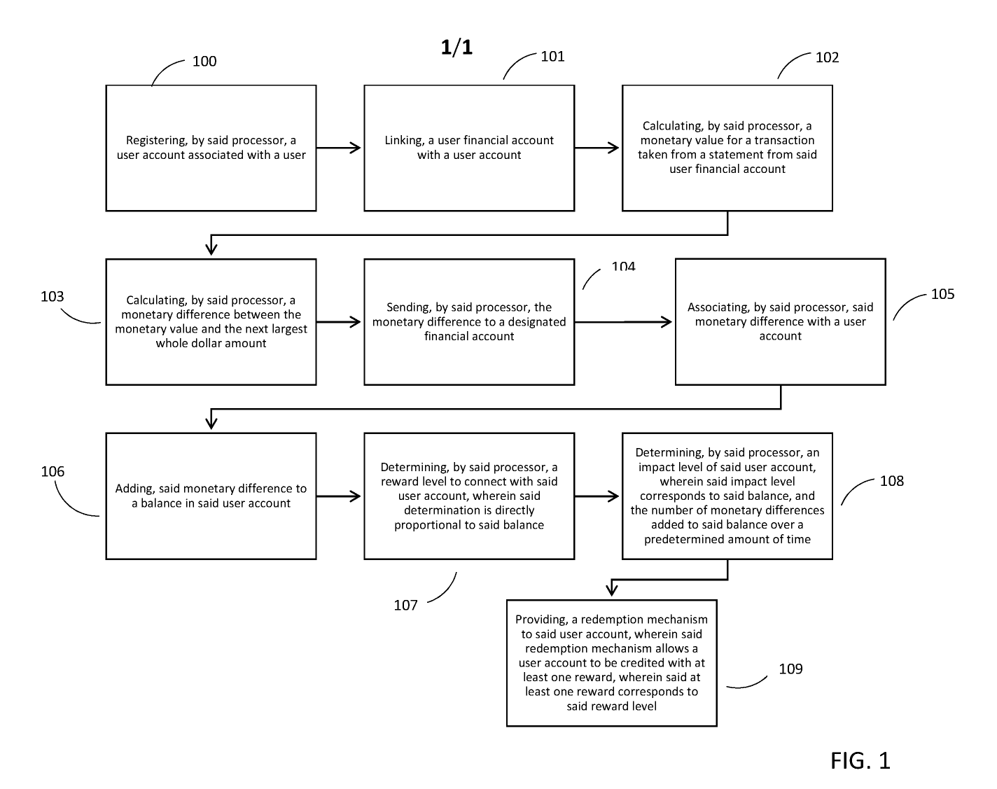

Referring to FIG. 1, an overview of an embodiment of the method of the present invention is shown. In step 100, a user registers an account to be associated with a user. This account will be used to interface with one of the various charities needing assistance in the city where the user is located. By registering with the application a user can earn rewards by directly sparing cents of their restaurant bills while eating out. In step 101, a user links a financial account of theirs with their user account. The present invention will use information from a statement for this financial account to determine the values to be used with the present invention in step 102. In step 103, the Round Up amount is automatically calculated. In some embodiments, there exists the optional step of a user selecting the restaurant they are currently in. In another embodiment, the present invention will recognize where the user is sitting from their wireless or Bluetooth connection or similar technologies such as RFID or NFC. Upon selecting the restaurant that the user is presently at, the restaurants which are participating in the reward system will display to the user a visual indicator. The visual indicator may illustrate to the user the amount of their bill, the amount of their Round Up or the reward which the user may qualify for by Rounding Up their bill. Finally there is a screen summarizing all the information given and the user is given the option of donating the Round Up amount. For example, for a bill amount of $26.43 the user would be charged $0.57 to Round Up to $27.00 or alternatively to donate the maximum amount ($0.99). In another embodiment of the application, In the event the restaurant is not a participating restaurant, the restaurant will be notified of the patron's bill and have the option of opting in to the present application's system.

After a selection is made, the user will be taken through a plurality of pay services in step 104, such as Apple Pay or the PayPal API flow, in which if no credit card information is stored (by PayPal) the user can take a picture of their credit card or enter the information manually. After the user has Rounded Up, a thank you screen will be displayed to remind. The user that they helped to feed a specified number of citizen in the state where the application or system is running. On this screen, I have the opportunity to share my donation on Facebook and/or Twitter. One possible message could be:
Andra just Rounded-Up @L&W Oysters. Her donation helped feed 3 New Yorkers. [iTunes link]

In step 105, the sending of the monetary difference in step 104 is associated with a user account, and in step 106 this monetary difference is added to a balance within this user account. In a preferred embodiment, a user of the application may gain rewards for visiting the same participating restaurant multiple times a month and Rounding Up each time. This is done in step 107. As an example, a user who visits a restaurant 3 times in a month awards the user with a free cocktail; a user who visits a restaurant 5 times in a month awards the user with a free appetizer or dessert; and a user who visits a restaurant 10 times in a month awards the user with a bill deduction of $15. The rewards tab allows a user to see their progress towards their rewards, as well as have the ability to redeem them (in step 109).

In step 108, the impact level of a user is determined. The present invention provides for a tab within the interface, the impact tab, to view this impact. There, a user may view: the total amount of donated money; total amount of meals donated; amount of Round Ups completed in a predetermined amount of time such as a month, day or year; total amount of money donated meals donated by the entire user base (this is the meal gap tracker); and a user's associated profile photo. The impact tab is dynamic; depending on the city and the charitable service that the user has selected.

In step 109, the present invention provides the user with a redemption mechanism to retrieve some of the earned rewards. For example, upon selecting the rewards tab a user can see a restaurant list view, similarly styled to the restaurant tab. Restaurants with pending rewards are shown at the top. Restaurants at which the user has Rounded Up this month, have an indicator of how many Round Ups have occurred. Restaurants at which the user has not yet visited this month are not shown. Upon selecting one of these partnering restaurants, the user is directed to a detail view.

On the detail view for a particular restaurant, the user is able to see all available rewards that they have accrued at this location. By selecting a particular reward icon which may be highlighted as available, will take a user to the countdown screen. Multiple rewards of a single type will be indicated with a badge and corresponding number. Claimed rewards in a specified time frame such as a month will be greyed out, and rewards yet to be earned will display the remaining Round Ups required. Additionally a history of the user's activity (Round Ups and reward redemptions) with the participating and selected restaurant will be displayed in a list.

When the user opts to redeem a reward, they will see a new screen showing the reward type to be claimed, the restaurant name, and a 10-minute countdown (broken down by minutes, seconds, milliseconds). There will be a claim button, which will activate the countdown. Once the countdown finishes the reward will no longer be claimable, and will have registered as “Claimed” in our database. In another embodiment of the application, the countdown time can be of varying time intervals.

In one embodiment, there exist screens that will inform a user about the invention's Rounding Up feature. That is, the application of the invention will allow a user to round up the total of their bill at a participating restaurant and the spare change generated by rounding up will be donated to a charity. These screens can also inform a user of the application of the invention's rewards program, as well as provide the user with a means to sign up for the service.

In one embodiment, the system will provide a user with a custom tab bar in the bottom of the user interface to help the user navigate through the application. When a user tries to access a feature which requires a profile, they'll be prompted to register an account. User may see the charity as well as pertinent information about said charity. In a preferred embodiment, a user has the ability to retrieve a lost password or to set a temporary password.

In other preferred embodiments, users will have the option of creating an account with their social media account. For example, this process could be completed with a user's Facebook account or with a user's email address. In either case, the user will be prompted to select their initial choice for a cause or charity to donate to. The system will not allow a user to move forward until at least one charitable service is created. User account registration will include a user's full name, email address, password, and an uploaded photo to be used as their profile. A user may also take a photo with their device or choose an existing photo. A user will be prompted create a new password if their password is forgotten and/or their password can be retrieved via email.

In yet another preferred embodiment, the present application comprises a list of venues, where a user can view a list of curated photos provided by venues of the participating restaurants. Restaurant and venue information of each venue is displayed. The restaurants and venues are sorted by name. In another embodiment the user can see their name. The restaurants can be sorted in a variety of ways including alphabetical, distance from current locations; or where users have visited most. Users can also search for a particular restaurant.

There is a tab on each list item indicating how many times the user has Rounded Up at this restaurant over the course of the current month. Alternatively if the user has Rounded Up exactly 3, 5, or 10 times at a particular location, it will be indicated that there is a reward available to claim for this location. For restaurants the user has not visited this month, no tab will be shown.

In the restaurant detail view, a user may select or search for a restaurant and view additional information on the restaurants such as the restaurants: location, opening hours, distance from the user's current location, phone number, a map where the restaurant is located, and the total amount of donated meals by the user base for that restaurant.

In a preferred embodiment of the application, a tab is located on the list view which may contain a plurality of times a user has Rounded Up their bill. The amount of completed Round Ups a person has completed may be shown in various increments. Such completed Round Ups may also be shown in a specified time frame, such as a day, week, month or year. If a user has not yet claimed their reward for Rounding Up, such information may be displayed on the list view. Any corresponding rewards for the amount of times a user has Rounded Up may be shown. In the event a user opts to redeem or use their reward, an additional header or tab may be shown to allow the user to unlock the reward. A user may also view a countdown screen where the user's reward is available for a predetermined and limited amount of time.

A user of the present application logs into the system and enters information for their profile. Such profile information is stored on the user's profile screen. Such information includes, a user's profile picture, name and email address. In another embodiment of the present application additional profile information may include, address; birthday; social media accounts of the user; and other personal and private information. A user may change any of this information, as well as the causes to which they choose to donate. The user can also log out from this tab. If they do so they are redirected to the Impact tab in a logged out state.

The present application allows a user to receive push notifications or reminders at least once a month and when new restaurants have been added. In another embodiment, a user may select a shorter or longer period of time and may be notified when new rewards are added. In addition, a user may be notified when milestones for the meal tracker have been met such as the total amount of people fed or donations raised.

Users may Round Up anywhere, but they will only receive rewards when at a member restaurant. Users can see the name, image and type of restaurant, its distance from the user's current location, and the number of Round Ups the user has made this month at each venue. Tapping on the venue in the system's application shows greater detail, displaying hours of operation, phone number, how many Round Ups a user is from their next reward, how many meals the user has donated at that establishment and a map view that opens into Google maps. In a preferred embodiment of the present application, venues may have either a triangle with a # in black or a reward in teal. The black triangles signify how many times the user has Rounded Up at that establishment this month.

In a preferred embodiment, when a user's 2^{nd} Round Up occurs within a specified period of time such as one month, the list view will display a triangle with the number 2 contained therein. On a user's 3^{rd} Round Up in 1 month, the list view will display a cocktail icon claim. Triangles with #'s will display on a user's 1^{st} 2^{nd} 4^{th}, 6^{th}, 7^{th}, 8^{th} & 9^{th} Round Ups in one month. Reward icons will display on a user's 3^{rd}, 5^{th} and 10^{th} Round Up in one month. Round Ups to get rewards expire monthly. However, in alternative embodiments of the present application, rewards can expire in longer or shorter periods of time and rewards may vary depending on the formula chosen by the restaurant or user. For example, if a user Rounds Up 2 times in October, and 1 time in September at City Hall Restaurant [a member restaurant], the user will not be eligible for a free cocktail because the 2 October Round Ups would no longer show up in the system's application. Once a user earns a reward, they are able to redeem it under the rewards screen whenever they want. Rewards don't expire, but Round Ups expire each calendar month. In another embodiment of the application, Round Ups nor rewards expire.

In another preferred embodiment, when a user taps the black triangle on the bottom center of the main screen of the systems application, they are prompted to take a picture of their receipt and then to enter their bill total. The Round Up amount is generated automatically as the bill total is entered. The user selects from a list the venue they are at. The list contains both participating and non-participating restaurants. When at a participating location, the user sees an overview, including a clear photo of the location and a teal icon indicating that the Round Up contributes toward rewards. Non-participating restaurants, shown in a different part of the systems application's screen, have a stock blurry image and no reward icon. Users are able to quickly donate $0.99 if they wish to maximize their impact. No donation over $0.99 is accepted. In another embodiment of the present application, maximum donation limits can be varied. In addition, donation maximums and minimums can be set by the participating user and restaurant.

If a Round Up occurs at a participating venue, the user is shown an overview of how many Round Ups they are away from their next reward at the venue. A statement is generated to indicate the impact that their donation has made i.e. “Andra just Rounded Up to feed 2 New Yorkers @BronxBeerHall with @SPARE”. This statement can be shared via Facebook, Twitter, or any other supported social media platform. If a user is on their 3^{rd}, 5^{th} or 10^{th} Round Up of the month, they are shown a message letting them know they can now claim a reward at the venue. If the venue isn't participating in the rewards program, the user sees a generic image instead of reward information.

Much like the venues list, a user will see information about venues, but only venues in which the user has Rounded Up in the past month, as well as venues with rewards the user has left to redeem. Remember, Round Ups expire each month, so Round Up from last month are useless, and only this month's Round Ups are shown. A detailed view of each location shows which rewards have been claimed, are ready to be claimed and are yet to be achieved. The systems application may display a history for that venue, showing the past Round Ups and reward claims. For example, the maximum that a user can earn in 1 month is 1 cocktail, 1 appetizer or dessert and $15 off after visiting and Rounding Up at that location 10 times in 1 month. In alternative embodiment of the application, the maximum number or rewards a user may claim and earn can be varied.

Tapping to claim a reward shows the reward redemption screen. A message is shown to inform the user that once they begin the countdown to claim, they will have only 10 minutes to get the attention of their bartender or server to redeem their reward after which the reward will permanently disappear. This can be avoided by getting the bartender/server's attention before activating the countdown as suggested. The 10-minute countdown is in place to protect the restaurant from users redeeming the same reward multiple times. The active countdown indicates to the venue that the user is ready to receive their reward.

The present application is able to store, track and analyze metadata of the user base and of the participating restaurants. For example, the present application may track and record the following statistics: total Round Ups, Round Ups the current month, Round Ups towards which charity, the amount of people per restaurant that Rounded Up in a given month, the amount per restaurant Rounded Up in a given month, the amount of rewards per restaurant redeemed in a given month, day or year, the most recent Round Ups per user has completed, amount of Round Ups per user has completed in the current month, day or year, amount of Round Ups per user has completed in total, rewards used per user in the current month, day or year, rewards used per user in total. The present application is able to filter the aggregated and recorded data in the following ways: amount of Round Ups within a certain time frame, Round Ups above/below/equal to a certain amount within a timeframe and the ability to suspend users.

The present application allows a user to donate (an extra) $0.99 in the application, make a reservation for a restaurant; utilize optical character recognition, take advantage of automatic email integration; and share reward points with other users. The present application consists of an application programming interface (API) that talks directly with the mobile app. Preferably, it is built upon the Django Web Framework, and uses Django Rest Framework to create the API. A suitable database for this backend to use is PostgreSQL. Further, in a preferred embodiment, both the server and database are hosted by Heroku; a cloud platform used to build and maintain web apps and backends. In another embodiment of the application, the application may be downloadable, non-downloadable, hosted on a computer or enterprise network, and utilize various databases and servers.

Users of the present application may create an account with the system. User accounts may be created with an email, a Facebook account or other social media outlets (i.e. LinkedIn and Twitter). The database of the present application stores the user's email, desired moniker, an optional profile picture, and a password. The password is hashed before it is stored in the database, so no passwords are in plain text. A user who uses their Facebook account may have their identity verified by the present applications system wherein the user's Facebook ID and the Facebook access token for the user is double checked and verified. Also, in yet another preferred embodiment, if the user is going to share data within the present applications system, the system will also store their twitter access token and (if not already a Facebook user) their Facebook access token.

When a user Rounds Up, the system's backend stores the user, restaurant, receipt image, Round Up amount, timestamps, the chosen charity and the PayPal transaction id in the database. Every time a Round Up occurs we double check the transaction amount with PayPal. For the rewards, the system's backend stores the type of reward, restaurant it is for, timestamps, whether the user has that reward, when the user redeemed the reward, and if the user redeemed the reward on the backend. When a user gains a reward it is stored on the backend waiting to be used. The information of the restaurants of the present applications on the mobile system is located on Foursquare. However, alternative databases and social media location software's may be used instead. In a preferred embodiment, the system's backend will save the restaurant's name, email, and Foursquare ID. When adding a restaurant to the system's backend the server searches the Foursquare API to find a matching restaurant and Foursquare ID. In another embodiment of the application, the system's backend may use alternative restaurants location and listing services such as Yelp or Open Table.

When a user Rounds Up, the Round Up is not completed or stored in the database until it is verified by PayPal or similar pay service application. Users will receive emails when registering with the system's application and when a user has forgotten their password. Restaurants will receive emails at the beginning of every month that will have the statistics, analytics and information from the previous month, such as the amount of rewards that were redeemed.

In another embodiment of the present application, the system may incorporate I-Beacon Technology to support proximity marketing and frictionless payments. In this embodiment of the application, each partner location or restaurant of the system would house the I-Beacon technology (or similar technology) which will enable communication between individual locations and users. Promotions, Specials, and Coupons may be sent directly to the user while the application or software is in use. The I-Beacon technology will also enable contactless payment, automatically signing the user into the partner location upon entry to the establishment and automatically Rounding-Up their bill upon exit. In this embodiment of the application, a predetermined amount: $0.50-$0.99 max may be used. In another embodiment of the application, partner locations will not be limited to restaurants, but will expand to include hotels and other larger chains.

In a preferred embodiment, custom push notifications or reminders may be geared toward an individual users' preferences as recorded by the system of the application. For example, if a user frequents French Restaurants, the system may suggest local French Cuisine locations and specials. Or, for example, if a user is partial to certain neighborhoods, the system notifies them of new openings/events in that region. The system of the present application a user may Round Up online through order-out sites like Seamless and through reservation sites like Open Table. The system may recognize these remote Round Ups so that a user can still count them toward earning rewards, and continue to track their impact on the meal gap. In another embodiment of the application, the system may capture the user as they have paid their bill and are ready to leave their current location. For example, a collaboration with a ride-sharing service, such as UBER®, could result in a simple “TAB IT & CAB IT” option being offered after the Round Up is complete. This may include a Rounding Up of the cab fare for each UBER purchase. In another embodiment of the present application, individual partner locations may control their communications with the individual user & vice versa. For example, a user may skip in line at the bar by pre-ordering their drinks ahead of time. Each order can correspond to a number and color combination that would flash on the system's application and shown to a bartender to indicate their pre-order.

The system of the present application allows individuals Round Up their bill to the nearest dollar to support the charity of their choice such as Food Bank for NYC or City Harvest. Each donation, always $0.99 or less, helps provide 4 meals to people in need. Users are able to track both how many people they've helped feed, and how many meals have been donated collectively by all users of the system. City residents may be inspired to close the current meal gap, which is around 235 million missing meals, by simply Rounding Up. To reward good behavior, participating restaurants offer freebies to users who Round Up frequently at their location. It's a standard formula: 3 Round=Ups in 1 month=1 free cocktail, 5 Round Ups in 1 month=free appetizer/dessert, 10 Round Ups in 1 month=$15 off. In another embodiment the formula can be adjusted per the user or restaurant.

In other embodiments there exists a settings tab, which allows a user to change the charities and causes that they would like to support, change the elements (pictures, name, email) of a user's profile, change the user's password, change social media settings, and add new causes to support.

There also exist embodiments where a global alert views are shown. These alerts are custom-styled to fit within the entirety of the rest of the application of the invention. For example, an alert informing a user of their use of an invalid email would be displayed via this screen. Further, this type of alert may be used when a user attempts to access a screen that requires them to be logged in.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

In a preferred embodiment, the present invention will display to a user how many meals have been generated using the present invention. It is also possible for a user to share information generated by the present invention with others via social media. In other embodiments, the present invention allows for a user to view all participating partners. In another embodiment, the present invention can monitor the date and amount of all Round Ups.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

The many elements of the present invention make it unique in the field. The novelty is illustrated by the various options for nearly every aspect of the invention that allow it to be used across a number of different platforms and in a number of different establishments.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for collecting microdonations, comprising the steps of:
providing an internet-enabled computing device comprising:
a memory, for holding a set of computer-readable instructions,
a processor, operatively connected to said memory, said processor configured to execute said set of computer-readable instructions;
linking, a user financial account with a user account;
calculating, by said processor, a monetary value for a transaction taken from a statement from said user financial account;
calculating, by said processor, a monetary difference between the monetary value and the next largest whole dollar amount;
sending, by said processor, the monetary difference to a designated financial account.

2. The method of claim 1, wherein said designated financial account belongs to a charitable organization.

3. The method of claim 1, wherein said designated financial account is belongs to an individual.

4. The method of claim 1, wherein said monetary difference is less than $1.00.

5. The method of claim 1, further comprising the steps of:
associating, by said processor, said monetary difference with said user account;
adding, said monetary difference to a balance in said user account;
determining, by said processor, a reward level to connect with said user account,
wherein said determination is directly proportional to said balance.

6. The method of claim 5, wherein said balance is reset on a preset interval.

7. The method of claim 5, further comprising the step of:
determining, by said processor, an impact level of said user account,
wherein said impact level corresponds to said balance, and the number of monetary differences added to said balance over a predetermined amount of time.

8. The method of claim 5, further comprising the step of:
providing, a redemption mechanism to said user account,
wherein said redemption mechanism allows a user account to be credited with at least one reward,
wherein said at least one reward corresponds to said reward level.

9. A system for collecting microdonations, comprising:
a memory, for holding a set of computer-readable instructions,
a processor, operatively connected to said memory, said processor configured to execute said set of computer-readable instructions,
wherein said processor is configured to perform the steps of:
registering, by said processor, a user account associated with a user;
linking, a user financial account with said user account;
calculating, by said processor, a monetary value for a transaction taken from a statement from said user financial account;
calculating, by said processor, a monetary difference between the monetary value and the next largest whole dollar amount;
sending, by said processor, the monetary difference to a designated financial account
associating, by said processor, said monetary difference with a user account;
adding, said monetary difference to a balance in said user account;
determining, by said processor, a reward level to connect with said user account,
wherein said determination is directly proportional to said balance;
determining, by said processor, an impact level of said user account,
wherein said impact level corresponds to said balance, and the number of monetary differences added to said balance over a predetermined amount of time;
providing, a redemption mechanism to said user account,
wherein said redemption mechanism allows a user account to be credited with at least one reward,
wherein said at least one reward corresponds to said reward level.

10. The system of claim 9, wherein said designated financial account belongs to a charitable organization.

11. The system of claim 9, wherein said designated financial account is belongs to an individual.

12. The system of claim 9, wherein said monetary difference is less than $1.00.

13. A non-transitory computer readable medium having stored thereon instructions for collecting microdonations based on a difference between a monetary amount on a receipt and a whole dollar amount which when executed by a processor to perform steps comprising:
linking, a user financial account with a user account;
calculating, by said processor, a monetary value for a transaction taken from a statement from said user financial account;
calculating, by said processor, a monetary difference between the monetary value and the next largest whole dollar amount;
sending, by said processor, the monetary difference to a designated financial account
associating, by said processor, said monetary difference with a user account;
adding, said monetary difference to a balance in said user account;
determining, by said processor, a reward level to connect with said user account,
wherein said determination is directly proportional to said balance;
determining, by said processor, an impact level of said user account,
wherein said impact level corresponds to said balance, and the number of monetary differences added to said balance over a predetermined amount of time;
providing, a redemption mechanism to said user account,
wherein said redemption mechanism allows a user account to be credited with at least one reward,
wherein said at least one reward corresponds to said reward level.

14. The medium of claim 13,
wherein said balance is reset on a preset interval.
